(19) United States
(12) Patent Application Publication
(10) Pub. No.: US 2015/0016701 A1
(43) Pub. Date: Jan. 15, 2015

(54) PULSE SEQUENCE-BASED INTENSITY NORMALIZATION AND CONTRAST SYNTHESIS FOR MAGNETIC RESONANCE IMAGING

(71) Applicant: The Johns Hopkins University, Baltimore, MD (US)

(72) Inventors: Amod Jog, Baltimore, MD (US); Snehashis Roy, Baltimore, MD (US); Aaron Carass, Baltimore, MD (US); Jerry L. Prince, Lutherville, MD (US)

(21) Appl. No.: 13/940,578

(22) Filed: Jul. 12, 2013

(51) Int. Cl. G06T 11/00

(52) U.S. Cl. CPC G06T 11/003
USPC 382/131

(57) ABSTRACT

According to one or more of the embodiments herein, a subject image of biological tissue is acquired from a pulse sequence of a magnetic resonance imaging (MRI) device, and one or more pulse sequence parameters used to acquire the subject image may be estimated based on a relationship between the subject image and the biological tissue. A new atlas image may then be synthesized using the pulse sequence and the estimated pulse sequence parameters of the subject image, and an intensity transformation between the new atlas image and a desired reference atlas image may be learned. As such, a desired subject image may be synthesized by applying the intensity transformation to the subject image.

### STATEMENT OF RIGHTS TO INVENTIONS MADE UNDER FEDERALLY SPONSORED RESEARCH

This work was supported by the following grants from the National Institutes of Health, Grant Numbers: [5 R21 EB012765]. The government has certain rights in the invention.

### TECHNICAL FIELD

The present disclosure relates generally to magnetic resonance imaging (MRI), and, more particularly, to pulse sequence-based intensity normalization and contrast synthesis for MRI.

### BACKGROUND

Magnetic resonance (MR) imaging (MRI) is currently the preferred imaging modality for neuroanatomy—that is, for the study of neuroanatomical structure and function in both clinical and research settings—because of its excellent soft tissue contrast and the absence of any ionizing radiation. Using a multitude of programmed is pulse sequences, MRI allows practitioners to image the brain with differing tissue contrasts, providing rich information about the underlying tissue (e.g., the brain). In particular, each of these tissue contrasts provides the opportunity to study unique features of various tissues, such as the growth of multiple sclerosis (MS) lesions through T₂-weighted (T₂-w) images or using T₁-weighted (T₁-w) images for surface reconstruction.

For reasons such as patient comfort, cost, and improving technology, certain tissue contrasts for a cohort analysis may not have been acquired during a given imaging session. For instance, only a few contrast images may have been acquired during any one session to reduce cost, decrease scan duration, increase patient convenience, and so on. It may also happen that a particular tissue contrast is only acquired with low resolution or is simply a bad image. The missing or inadequate pulse sequence hampers consistent neuroanatomy research, and may also introduce inconsistency in processing a large multi-subject dataset that has such missing or unusable data. Specifically, there may be datasets where a particular contrast would have been useful but was not acquired (sufficiently) for various reasons, such as the fact that certain pathologies are best understood when studied with a particular pulse sequence.

Furthermore, MRI scans are often collected on many different scanners and at many different sites, and the quality of these images is highly dependent on the imaging parameters and the calibration of the scanners, the variations of which lead to vastly differing intensity profiles for images. Intensity normalization is an important preprocessing step in MRI analysis, where the observed intensities are primarily dependent on (1) intrinsic magnetic resonance properties of the tissues such as proton density (P_{D}), longitudinal and transverse relaxation times (T₁ and T₂ respectively), and (2) the scanner imaging parameters like echo time (TE), repeat time (TR), and flip angle (α). It is a fundamental problem of MR imaging that the image voxel intensities do not have any specific numeric meaning, unlike computed tomography (CT). The performance of image analysis routines like segmentation and registration is dependent on the underlying intensity distribution, which can be made consistent through intensity normalization or standardization.

Previous work on intensity normalization focuses primarily on histogram matching. Histogram matching often suffers from quantization artifacts, yielding unnatural appearing images. Additionally, forcing a subject image histogram to match a reference forces the tissue intensity distribution of the subject to be equal to that of the reference. This can have unwanted consequences if the subject and the reference brain anatomies differ by a significant amount. Landmark-based approaches result in using linear, piecewise linear, or polynomial intensity transforms calculated from landmarks on intensity histograms. These types of one-to-one transforms are insufficient to model the highly nonlinear variations introduced in different images by the MR imaging physics. Other more recent work uses multiple images and focuses on matching multidimensional histograms of the subject and the reference. Though these methods can result in a nonlinear, many-to-many transform, the basic issue of forcing the subject joint histogram to match a reference joint histogram remains.

### SUMMARY

According to one or more of the embodiments herein, a subject image of biological tissue is acquired from a pulse sequence of a magnetic resonance imaging (MRI) device, and one or more pulse sequence parameters used to acquire the subject image may be estimated based on a relationship between the subject image and the biological tissue. A new atlas image may then be synthesized using the pulse sequence and the estimated pulse sequence parameters of the subject image, and an intensity transformation between the new atlas image and a desired reference atlas image may be learned. As such, a desired subject image may be synthesized by applying the intensity transformation to the subject image.

In one embodiment, the desired subject image comprises an intensity normalized is image of the subject image and the desired reference atlas image comprises an image to which the subject image is normalized.

In another embodiment, the desired subject image comprises a selected pulse sequence image of the subject image and the desired reference atlas image comprises a reference atlas image of the selected pulse sequence.

In another embodiment, the selected pulse sequence comprises one of either a pulse sequence not obtained by the MRI for the biological tissue or a pulse sequence not obtainable by the MRI for the biological tissue.

In still another embodiment, the estimated pulse sequence parameters comprise one or more of repetition time (TR), echo time(s) (TE), flip angle (alpha), and scanner gain (A0).

In yet another embodiment, estimating the pulse sequence parameters is based on known mean intensities of tissue classes for biological tissue and known mean values for tissue properties for the tissue classes.

In another embodiment, tissue classes are selected from a group consisting of: white matter (WM), grey matter (GM), and cerebrospinal fluid (CSF).

In still another embodiment, tissue properties are selected from a group consisting of: proton density (PD), longitudinal relaxation time (T1), and transverse relaxation time (T2).

In one embodiment, learning the intensity transformation between the new atlas image and the desired reference atlas image is based on one or more nonlinear regression learning algorithms.

In yet another embodiment, synthesizing the new atlas image comprises estimating a theoretical betaspace for properties of the biological tissue by applying a plurality of intensities to pulse sequence equations based on the estimated pulse sequence parameters, and applying a desired pulse sequence equation for the desired pulse sequence to the theoretical betaspace to synthesize the new atlas image.

In another embodiment, the pulse sequence equations comprise approximations.

In still another embodiment, acquiring the subject images comprises a plurality of image acquisitions.

In yet another embodiment, the reference atlas may be augmented to include synthesized atlas images using the subject image pulse sequence and the corresponding subject image pulse sequence parameters.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example flow diagram of a four-step process for image normalization and/or image synthesis according to one or more embodiments herein;

FIG. 2 illustrates an example table comparing synthesis techniques;

FIG. 3 illustrates a visual example comparison between synthesis techniques;

FIG. 4 illustrates an example table comparing mean intensity between synthesis (e.g., normalization) techniques;

FIG. 5 illustrates another visual example comparison between synthesis techniques;

FIG. 6 illustrates an example simplified procedure for providing for pulse sequence-based intensity normalization and contrast synthesis for MRI; and

FIG. 7 is a schematic block diagram of an example computing device.

### DETAILED DESCRIPTION OF ILLUSTRATIVE EMBODIMENTS

All the above mentioned techniques overlook a vital point while performing intensity normalization, the magnetic resonance (MR) imaging (MRI) physics, and its effect on tissue biology. The contrast obtained in an MR image is dependent on imaging parameters like repetition time TR, single or multiple echo times TEs, and flip angle (α). It is also dependent on the physical properties of the underlying tissue such as the proton density P_{D}, and the longitudinal and transverse relaxation times, T₁ and T₂ respectively. (Notably, other parameters may affect pulse sequences, such as the “T₂-star”, chemical shift, susceptibility, diffusion, etc., and the techniques herein are not limited to P_{D}, T₁, and T₂.) In particular, in MRI, unlike Computed Tomography (CT), the image intensities do not have a tissue specific numerical meaning across different scanners and subjects, where the recorded signal intensity depends on the MR scanner parameters and the biological (P_{D}) and nuclear magnetic resonance (NMR) properties (T₁, T₂) of the tissue being imaged.

As described in greater detail below, the techniques herein provide an image based way of estimating these imaging parameters and subsequently estimates what we call betaspace, which is a theoretical space of the tissue biological and NMR properties (e.g., the intrinsic biophysical properties β=[P_{D}, T₁, T₂] or others). The techniques herein use multiple (e.g., three) images derived from multiple pulse sequence acquisitions of the same subject. In a first aspect, the techniques herein estimate the imaging parameters of these pulse sequences. Knowledge of the mean values of the tissue properties of various tissue classes can be assumed, such as the three major tissue classes in the brain: the white matter (WM), grey matter (GM), and cerebrospinal fluid (CSF). Using these and the known pulse sequence equations, the techniques herein can estimate the imaging parameters for all the pulse sequences. With knowledge of the imaging parameters, the techniques herein use this knowledge in the pulse sequence equations and multiple intensities at each voxel from these sequences, to estimate the betaspace. After the betaspace is estimated, the techniques herein can apply any pulse sequence equation to it and synthesize a completely new image. On understanding the structure of betaspaces, the techniques herein can even synthesize an image, which cannot be generated by an actual pulse sequence on a scanner. A pulse sequence is essentially a function which projects the betaspace values to produce intensities. Knowing the tissue betaspace values, the techniques herein learn pulse sequences, which will have contrasts, tailored to demand.

Notably, the imaging equations used for most pulse sequences are fairly complex and difficult to solve. To circumvent this issue, the techniques herein provide newly defined approximations of these equations, which are generally simple in form, easy to solve, and can be described by a small number of parameters. These are also robust to numerical solution methods and provide a consistent synthesis.

An immediate application of this technology is intensity normalization or standardization. As mentioned earlier, the MRI intensity profiles are inconsistent across scanners and subjects. This makes comparison between different MR studies difficult and furthermore one cannot merge these un-normalized data sets together and derive more meaningful results. However, given a reference image, the techniques herein can estimate the imaging parameters of the pulse sequence used, and learn the intensity transformation between the subject pulse sequence and the reference pulse sequence as a nonlinear regression on image patches. For instance, given three images, the techniques herein can generate the betaspaces for all subjects in a study. To synthesize normalized images, the techniques herein apply the reference pulse sequence equation to the subject betaspaces. This will result in new subject images generated as if by using the reference pulse sequence. This technology is computationally fast and can be implemented directly on the MR scanner in order to ensure that all future MR scans are normalized at acquisition.

As MR scanner technology progresses, newer and better pulse sequences are being invented. The data from these new sequences will not exist in the older studies. Sometimes for a study, certain data is missing due to a variety of reasons. The techniques herein help by synthesizing this missing data from the existing images. In this manner, the techniques herein have the ability to synthesize as a post-processing method. These methods can be easily used in post-processing to standardize different multi-site datasets to perform consistent and more meaningful neuroanatomy research.

The image intensity at a voxel is essentially a projection of the betaspace values at the voxel onto a pulse sequence equation. Better understanding of the betaspaces will allow the techniques herein to synthesize images, which cannot yet be synthesized by a real scanner. If the sequence is known, this technology allows an MR technician to interactively change the imaging parameters and observe the synthesized images in real time. He or she can then choose the best one without having to image the subject multiple times.

Understanding betaspaces of different abnormal tissue types like multiple sclerosis lesions, tumors, etc. will help in knowing which contrasts are best for visualizing these and for image processing routines like segmentation.

According to one or more of the embodiments described below, the techniques herein produce synthetic MR images, which are true to the underlying biology and the MR imaging physics. As mentioned, the signal intensity in an MR image is primarily dependent on MR scanner pulse sequence parameters like repetition time (TR), echo time/s (TE), flip angle (α), scanner gain (A₀), as well as tissue properties like proton density (P_{D}), and tissue nuclear magnetic resonance (NMR) properties like longitudinal relaxation time (T₁) and transverse relaxation time (T₂). The techniques herein focus on recovering the tissue properties for a subject using multiple pulse sequence acquisitions and using these tissue properties to synthesize new images by existing or novel imaging equations (where the novel imaging equations need not have a corresponding real life pulse sequence, which is implementable on a scanner).

To that end, the techniques herein generally comprise one or more of the features described below:

1) An image-based estimation of pulse sequence parameters for a given image of a known sequence (e.g., repetition time (TR), echo time/s (TE), flip angle (α), scanner gain (A₀), inversion time (TI), etc.), based on the following knowledge:
a) Mean intensities of the three primary tissue classes in the human brain, white matter (WM), gray matter (GM) and cerebrospinal fluid (CSF); and
b) Mean [P_{D}, T₁, T₂] values for the same classes used from previous literature.
   This results in three equations and three/four unknowns and can be solved with further assumptions, to estimate the pulse sequence parameters by standard solvers.

2) Use of multiple image acquisitions (e.g., three) of the same subject acquired is using different pulse sequences, along with their known pulse sequence equations, to estimate a theoretical space which is closely linked to biological tissue properties like proton density (P_{D}) and nuclear magnetic resonance tissue properties like the longitudinal and transverse relaxation times (T₁ and T₂ respectively). The recovered three dimensional space, henceforth called a betaspace, thus consists of [P_{D}, T₁, T₂] values or functions of these values for each voxel of the image. Notably, the proposed method can be shown to work with T₁-weighted spoiled gradient recall echo (SPGR), magnetization prepared gradient recall echo (MPRAGE), P_{D}-weighted and T₂-weighted double spin echo sequence and fluid attenuated inversion recovery (FLAIR) pulse sequence image data.

3) Simplification of the pulse sequence equations by using novel approximations of those pulse sequence equations, which can be described completely by a small number of parameters. In particular, the techniques herein result in expediting the abovementioned methods and make them much more robust, as the approximations can specify a particular pulse sequence in three or fewer number of parameters.

4) Synthesizing a new image of a different contrast by applying the relevant pulse sequence equations or their approximations to the tissue properties (P_{D}, T₁, T₂ for example). For instance, the techniques herein may apply the methods in 1) and 2) above as initial steps to recover the betaspace, and then apply a novel imaging equation to the betaspace and synthesize a new image. The imaging equation need not be that of an existing pulse sequence. A new imaging equation can be learned from a training betaspace and the corresponding desired signal intensities, thus allowing the use of completely exotic pulse sequences which need not be physically implementable on a scanner.

5) In case of an existing pulse sequence being used, synthesis of a new image by means of software, e.g., directly on the MRI scanner software, by allowing the technician to change the imaging parameters interactively and to observe and select the best images is in real-time as each of the imaging parameters are varied, without actually imaging the subject with those particular imaging parameters.

6) Standardizing intensity profiles of different MRI images from completely different studies in order to make the image processing and further results based on that image processing consistent and applicable to all the data from all the studies involved, and thus broaden the scope of research. Given a reference image, the method described in 1) can be used to estimate the imaging parameters used in the reference pulse sequence equation. This estimated reference equation can be applied to the betaspace recovered from the images in the studies to synthesize new images which will be standardized to the given common reference. Accordingly, scientists can then pool the studies together and derive statistically more meaningful results.

7) Synthesizing different pulse sequence images from a given image of a certain pulse sequence, by learning the intensity transformation as a nonlinear regression from a set of atlas images or training data. In other words, a proposed method synthesizes a different pulse sequence image from a given subject image by applying a nonlinear regression on the image patches of the subject, where the nonlinear regression may be learned from a pair of images, which act as the training data.

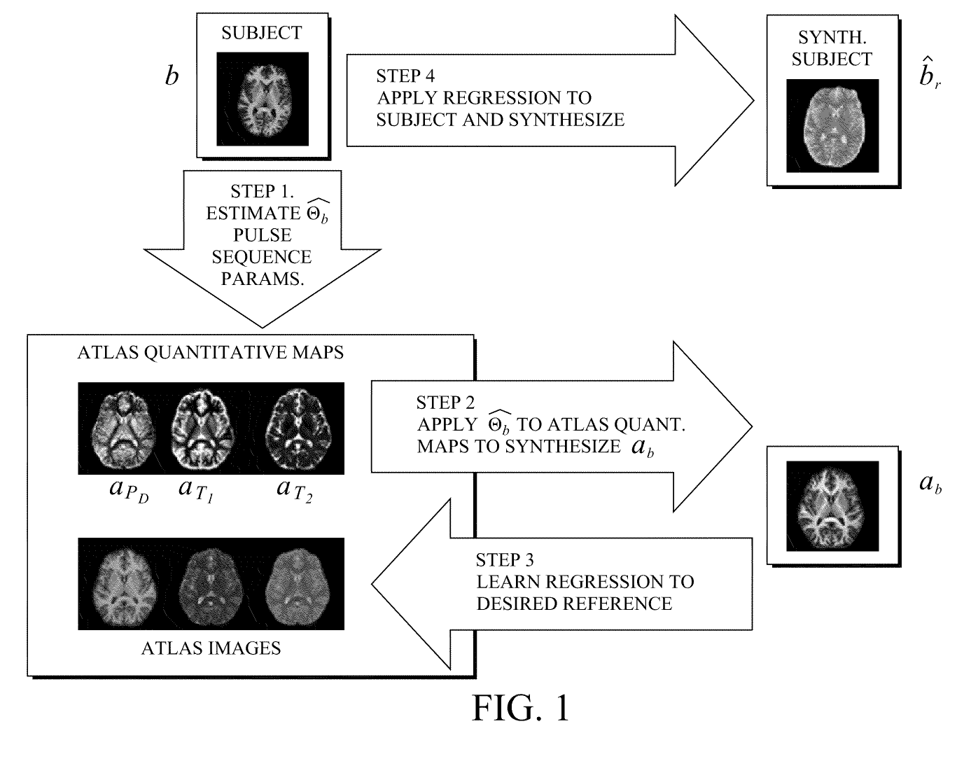

8) Standardizing the intensities of a given subject image to a reference atlas image, and/or synthesizing an alternate pulse sequence image for a given subject image (where the alternate pulse sequence data exists in the atlas). That is, assuming the knowledge of the atlas betaspace, the previously mentioned methods can be used for image normalization and/or image synthesis, using a four-step algorithm as shown in FIG. 1. Consider an atlas set of images, which consists of different images of the same person with different pulse sequences as well a map of the biological NMR properties like P_{D}, T₁ and T₂. The steps, with reference to FIG. 1, are as follows:
Step 1: Estimate the pulse sequence parameters of the subject image by method described in (1).
Step 2: Applying this pulse sequence equation to the known biological properties of the atlas (the atlas betaspace) to synthesize an atlas image.
is Step 3: Learning the intensity transformation between the synthesized atlas image and the reference atlas image via nonlinear regression learning algorithms (i.e., learning a nonlinear regression from the synthesized atlas image to the reference atlas image).
Step 4 (option a): Applying the learned nonlinear regression transformation to the given subject image to synthesize a normalized subject image (i.e., where for a given subject image, normalization means transforming the intensities in a biologically valid manner to match those of a corresponding atlas image).
Step 4 (option b): Applying the learned nonlinear regression transformation to the given subject image to synthesize a new subject image which has the same pulse sequence as one of the atlas images.

### “Pulse Sequence Retrieval and Regression” (PSRR)

A classical atlas-based approach to solve the problems noted above in the Background is detailed in the Mathematical Textbook of Deformable Neuroanatomies (1993) by Miller, et al. Given a subject image b₁ with contrast C₁ and a pair of co-registered atlas images a₁ and a₂ of contrasts C₁ and C₂, respectively, a₁ is registered to b₁ using a deformable registration algorithm. Then the same transformation is applied to a₂ in order to produce the synthetic \hat{b}₂ with contrast C₂. However, registration is never perfect and has difficulty reproducing the fine detailed differences around the cortex. A more recent method based on reconstruction by sparse priors on image patches was proposed by Roy, Carass, and Prince, in “A Compressed Sensing Approach For MR Tissue Contrast Synthesis” (In: 22nd Conf. on Inf. Proc. in Medical Imaging (IPMI). pp. 371-383 (2011)). However this approach treats this problem as a direct pattern matching problem and ignores the complex implications of the MR imaging physics of different pulse sequences. The techniques herein use a pattern regression approach that also incorporates the knowledge of MR imaging physics and the underlying tissue parameters which give rise to the intensities in an MR image. The core idea to explore the tissue parameters was previously used in an article by Fischl et al., entitled “Sequence-Independent Segmentation of Magnetic Resonance Images” (Neurolmage 23(S1), S69-S84 (2004)), however that approach requires the acquisition of very specific pulse sequences—a problem the techniques herein do not have. Though the techniques herein are designed to handle the missing pulse sequence problem, they can also carry out scanner normalization, which is just a special case of the problem. As noted, differing scanners and imaging parameters produce very different intensity profiles, which is a problem for multi-site, multi-scanner data. There has been a considerable amount of work to solve this problem, especially with histogram matching (HM) (single and multidimensional), such as in “Whole Body MRI Intensity Standardization” by Jager, et al., (Springer (2007)). An inherent flaw of HM methods is the requirement that the atlas and subject be reasonably similar to begin with. If they have very different histograms then they have different tissue distributions and using HM will result in eventual misclassification of tissues. Other methods, such as the one proposed by Nyúl, et al. in “New Variants of a Method of MRI Scale Standardization” (IEEE Trans. Med. Imag. 19(2), 143-150 (2000)), propose a HM using landmarks or a tissue class-matched piecewise-linear or polynomial transform to reference intensities. This, however, results in a one-to-one intensity transform which does not model realistic behavior. Another application of the techniques herein is to synthesize high resolution images to replace the acquired low resolution images. MPRAGE images are usually acquired with a higher resolution than double spin echo images. The techniques herein can thus synthesize a synthetic T₂-w image using its corresponding MPRAGE image and a high resolution atlas.

The techniques herein may generally be referred to as “Pulse Sequence Retrieval and Regression” (PSRR). The four step algorithm to perform image synthesis shown in FIG. 1 is described in more detail now below.

Let b be the given subject image, imaged with a pulse sequence γ_{b}—Magnetization Prepared Rapid Gradient Echo (MPRAGE) or Spoiled Gradient Recalled (SPGR), for example. A={a₁, a₂, . . . , aₙ} is the atlas collection, with contrasts C₁, C₂, . . . , Cₙ, generated by pulse sequences Γ₁, Γ₂, . . . , Γₙ, respectively. A goal of the techniques herein is to synthesize the subject image \hat{b}₂ which is how the subject brain would look had it been imaged with pulse sequence Γᵣ, which was used to acquire the atlas image aᵣ. First, 1) Estimate the pulse sequence parameters used to acquire b; 2) With this estimate, generate a_{b} the atlas image with contrast C_{b}; 3) From the atlas collection A and a_{b} the techniques herein learn the nonlinear intensity transformation between a_{b} and any of the atlas images, aᵣ, rε{1, 2, . . . , n}, as desired; 4) The intensity transformation is then applied to b, synthesizing \hat{b}ᵣ. The pulse sequence parameter estimation is achieved through a simplification of the pulse sequence equations and assumptions about feasible parameter values. The intensity transformation is learned as a regression on image patches by a bagged regression ensemble.

Regarding estimation of the subject pulse sequence model (Step 1), the intensity observed at voxel location x in b is a result of the underlying tissue parameters—proton density (P_{D}), longitudinal (T₁) and transverse relaxation times (T₂)—denoted by β(x)=[P_{D}(x), T1(x), T₂(x)]. The intensity is also a result of the pulse sequence used, Γ_{b}, and its imaging parameters denoted Θ_{b}. Thus the imaging equation can be denoted as,

b(x)=Γ_{b}(β(x);Θ_{b}) Eq. 1

For the double spin echo (DSE) sequence, the equation is,

$$b ( x ) = {Γ}_{b} ( β ( x ) ; {Θ}_{b} ) = {G}_{b} {P}_{D} ( x ) ( 1 - 2 {e}^{- \frac{TR \frac{{TE}_{1} + {TE}_{2}}{2}}{{T}_{1} ( x )}} + 2 {e}^{- \frac{TR \frac{{TE}_{1}}{2}}{{T}_{1} ( x )}} - {e}^{- \frac{TR}{{T}_{1} ( x )}} ) {e}^{- \frac{{TE}_{2}}{{T}_{2} ( x )}} , \qquad Eq . 2$$

where Θ_{b}={TR, TE₁, TE₂, G_{b}} consisting of repetition time (TR), two echo times (TE₁, TE₂) and the scanner gain (G_{b}). The human brain is dominated by three primary tissues, cerebro-spinal fluid (CSF), gray matter (GM), and white matter (WM). The techniques herein assume that the average values of β(x)=[P_{D}(x), T₁(x), T₂(x)] are known for these three classes: β̅_{C}, β̅_{G}, and β̅_{W} for CSF, GM, and WM respectively for 3.0 Tesla (3T) MRI (e.g., as discussed in “NMR Relaxation Times in the Human Brain at 3.0 Tesla” by Wansapura, et al., in Jrnl of Mag. Reson. Imaging 9(4), 531-538 (1999)). The techniques herein denote the mean intensities of CSF, GM, and WM in b as: b̅_{C}, b̅_{G}, and b̅_{W}, respectively, and assume that the average tissue parameter values result in average tissue intensities in the image. Mathematically these relations can be written as,

b̅_{C}=Γ_{b}( β̅_{C};Θ_{b}), b̅_{G}=Γ_{b}( β̅_{G};Θ_{b}), b̅_{W}=Γ_{b}( β̅_{W};Θ_{b}) (Eq. 3)

The techniques herein calculate the average tissue intensities by running a simple three class fuzzy c-means algorithm (e.g., as described by Bezdek in “A Convergence Theorem for the Fuzzy ISO-DATA Clustering Algorithms”, in the IEEE Trans. on Pattern Anal. Machine Intell. 20(1), 1-8 (1980)) on b and by choosing the voxels with high class memberships (≧0.8). Thus in the system of Eq. 3, the only unknown is Θ_{b}. For sequences like DSE, Θ_{b} is parameterized in terms of four unknowns, as shown above. Similarly the MPRAGE and SPGR imaging equations (e.g., discussed in “Optimization of 3-D MP-RAGE Sequences for Structural Brain Imaging” by Deichmann, et al. (Neurolmage 12(1), 112-127 (2000)) and in the “Handbook of MRI Pulse Sequences, vol. 18” by Glover (Elsevier Academic Press (2004))) can be described in terms of four parameters. The techniques herein can derive an approximate estimate \hat{Θ}_{b}, by solving the system of equations for three of the unknowns by Newton's method after fixing one of the unknowns that is reliably known from the image header information. Unknowns that are often not well-calibrated in an MR scanner, such as tip angle, are then estimated. Note that it is unlikely that an atlas of the techniques herein would contain an image with the exact pulse sequence parameters just estimated, which is why the next step may be required.

For synthesizing the atlas image with a subject pulse sequence estimate (Step 2), the techniques herein use the estimated imaging parameters, \hat{Θ}_{b}, to apply the pulse sequence to the atlas values to synthesize an atlas image with the same pulse sequence F_{b}. The atlas A={a₁, a₂, . . . , aₙ} consists of a set of co-registered brain MR images of a single brain with different pulse sequences. Without loss of generality, it can be assumed that the atlas consists of α_{P}_{_{D}}, α_{T}_{₁}, and α_{T}_{₂}, the quantitative P_{D}, T₁, and T₂ maps for the atlas. Thus, the techniques herein can directly apply the subject pulse sequence, Γ_{b}, and is its estimated \hat{Θ}_{b} to synthesize a new atlas image a_{b}. The techniques herein use this intermediate step to learn the intensity transformation between the subject pulse sequence Γ_{b} and the reference pulse sequence Γᵣ in a common image space, which is the atlas image space.

In practice the atlas collection A may lack the quantitative P_{D}, T₁, and T₂ maps. The relaxometry sequence data is generally not available for most clinical data. Regardless, the techniques herein are not restricted by the lack of this data. In particular, the techniques herein can approximately estimate these maps from the images present in the atlas collection by solving for P_{D}, T₁, and T₂ at each voxel, using three images (e.g., effectively estimating these values from P_{D-w}, T₂-w, and T₁-w image sets).

For learning and applying nonlinear regression on image patches (Step 3 and Step 4), having synthesized the atlas image a_{b} which has the pulse sequence characteristics of the subject image b, the techniques herein next learn the intensity transformation which will convert the intensities observed in a_{b} to the corresponding intensities observed in the reference atlas image aᵣ. This is achieved through a nonlinear regression by considering the image patches of a_{b} together with the corresponding central voxel intensities in aᵣ. The techniques herein extract p×q×r sized three dimensional patches from a_{b}, centered at the i^{th} voxel—for example, experimentally p=q=r=3. The techniques herein stack the 3D patch into a d×1=27×1 vector and denote it by bᵢεR^{d}, which the techniques herein consider as a feature vector. The corresponding intensity at the i^{th} voxel of aᵣ is denoted by rᵢ and acts as the dependent variable. The techniques herein thus construct the training data set of pairs of <bᵢ; rᵢ>. The techniques herein use a bagged ensemble of regression trees to learn this nonlinear regression (e.g., such as described by Breiman in “Bagging Predictors” from Machine Learning 24(2), 123-140 (1996)). An illustrative size of the training data is N˜10⁶ and the techniques herein illustratively use 30 trees in the ensemble, though synthesis by a standalone regression ensemble may be used. Once the training is complete, the trained regression ensemble transforms intensities of a_{b} to those of aᵣ. This ensemble is used to synthesize the subject image \hat{b}ᵣ. This is done by extracting the image patches from b and applying the trained regression ensemble to each is patch to synthesize the corresponding \hat{b}ᵣ voxel intensities.

Results on synthesis of T₂-w images, scanner normalization and high resolution synthesis are now discussed. In particular, the techniques herein produce intermediate images required for further image processing steps, and the desired results are as close to the truth as possible. Hence validation was performed by comparing the synthesized images obtained in accordance with the techniques herein with ground truth images using image quality measures. Also, intensity normalization was performed using the techniques herein, followed by a segmentation to show that the segmentation results are more consistent. Lastly, high resolution images were synthesized and compared visually with the actual acquired data.

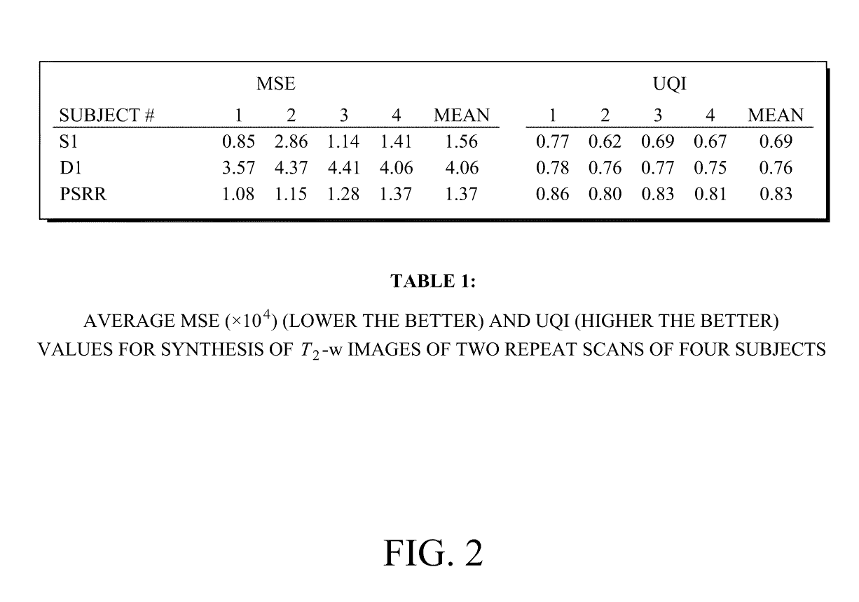

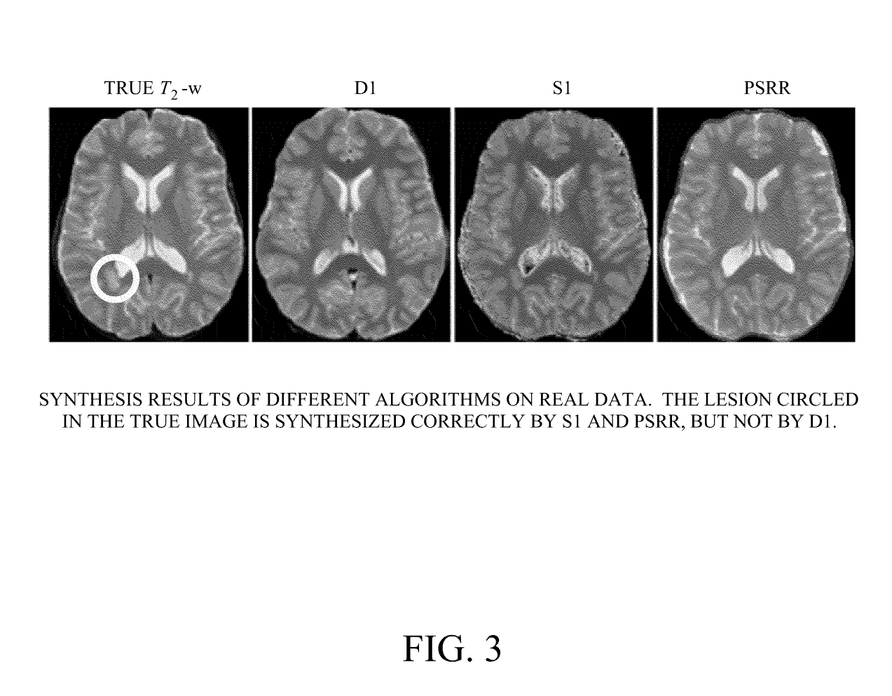

For Kirby Data Synthesis, T₂-w images were synthesized according to the techniques herein from MPRAGE images of four subjects for publicly available data (e.g., from Landman et. al.'s “Multi-Parametric Neuroimaging Reproducibility: A 3-T resource study” in NeuroImage 54(4), 2854-2866 (2011)). Each subject has two MPRAGE (1.2×1.2×1.2 mm³) acquisitions and two corresponding DSE T₂-w (0.82×0.82×1.5 mm³) and P_{D}-w images, which are co-registered. These images were acquired on the same scanner within a short duration of each other. As atlas a fifth subject was used with similar data and computed approximate P_{D}, T₁, and T₂ maps. For each MPRAGE subject image, a T₂-w image of the subject was synthesized. As the atlas belongs to the same dataset and was imaged on the same scanner with the same pulse sequence, the subjects' true T₂-w and synthesized T₂-w images can be compared directly, using MSE (mean squared error) and UQI (universal quality index) (e.g., such as discussed by Wang, et al., in “A Universal Image Quality Index” in IEEE Signal Proc. Letters 9(3), 81-84 (2002)). The sparse prior approach was implemented, denoted by S1 (e.g., from “A Compressed Sensing Approach For MR Tissue Contrast Synthesis” above) and the deformable registration based approach (e.g., from the “Mathematical Textbook of Deformable Neuroanatomies” above), denoted by D1. The deformable registration algorithm used in D1 was “SyN” (e.g., as defined by Avants, et al., in “Symmetric Diffeomorphic Image Registration with Cross-Correlation: Evaluating Automated is Labeling of Elderly and Neurodegenerative Brain” in Medical Image Analysis 12(1), 26-41 (2008)). As can be seen in Table 1 of FIG. 2, the techniques herein (PSRR) provide a better quality synthesis in comparison to both S1 and D1. A problem with the deformable registration approach is the spatial distribution of tissues has to be consistent between the atlas and subject image. This can be seen in FIG. 3, where D1 fails to correctly synthesize a lesion. The result of S1 is quite noisy. Visually it is clear that PSRR provides the best synthetic image, despite a few boundary artifacts.

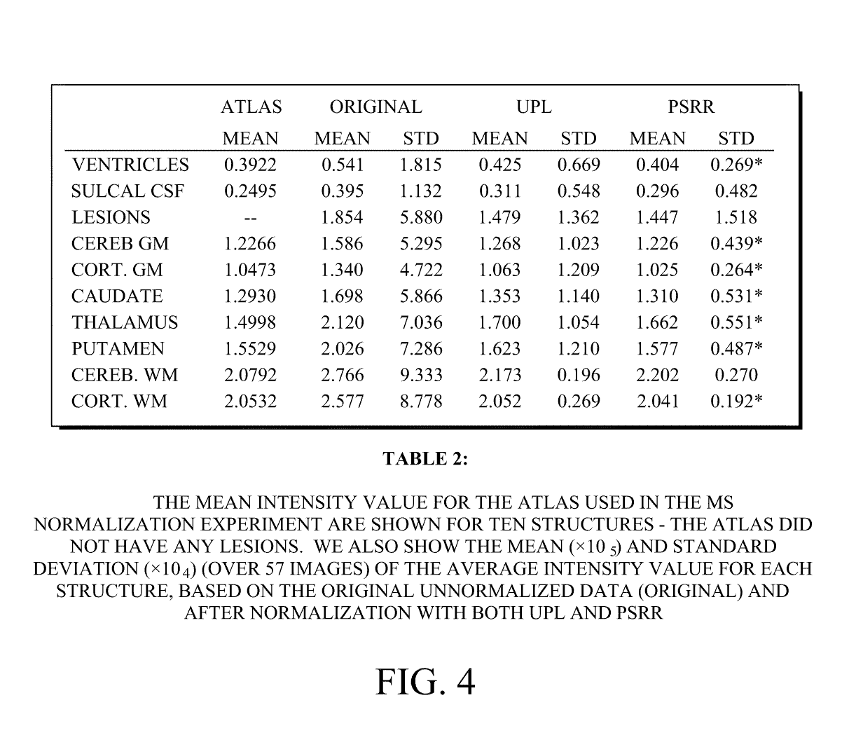

For Multiple Sclerosis (MS) data normalization, to test the normalization performance of the techniques herein, the algorithms described above were applied to 57 MPRAGE datasets representing 15 MS subjects. These acquisitions span multiple time points and were imaged on different scanners, albeit with the same imaging sequences. Preprocessing of the images included skull-stripping and field inhomogeneity correction (e.g., as described in “A Nonparametric Method for Automatic Correction of Intensity Nonuniformity in MRI Data” by Sled et al., in IEEE Trans. Med. Imag. 17(1), 87-97 (February 1998)). The atlas consisted of an MPRAGE and a P_{D}-w and T₂-w pair of images from a DSE of a normal subject, not belonging to the MS data collection. Approximate P_{D}, T₁, and T₂ maps were calculated as described above to complete the atlas set. The atlas MPRAGE was used as reference to bring the MS subjects into a common intensity scale. To demonstrate this, the original MS MPRAGE datasets were segmented (e.g., according to “A Topology-Preserving Approach to the Segmentation of Brain Images with Multiple Sclerosis Lesions” by Shiee et al., in Neurolmage 49(2), 1524-1535 (2010)), resulting in ten labeled structures. Using these structures as reference, the mean intensity was compared within these structures prior to normalization and after normalization with the landmark based piecewise linear approach, referred to as UPL (e.g., as described in “New Variants of a Method of MRI Scale Standardization” above), with the same normal reference MPRAGE described above and the techniques herein (PSRR). The results are shown in Table 2 of FIG. 4. The mean intensity values demonstrate that our method is moving the MS data intensities closer to the atlas intensities, as desired by normalization. A one tailed F-test on the mean structure intensities after normalization shows that the standard deviation achieved by PSRR is significantly smaller in comparison to UPL for is seven of the ten structures. We also note that the statistical significance does not change if the segmentation is done on the original data or on the normalized versions.

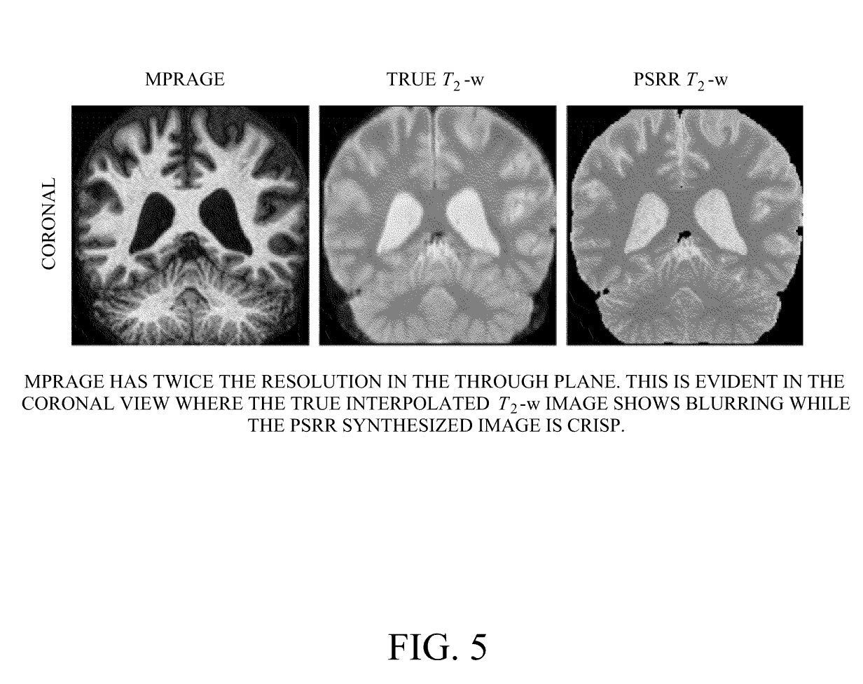

For MS data high resolution synthesis, the techniques herein were applied to synthesize a higher resolution version of a T₂-w image than what was available from the scanner. Example-based synthesis of high resolution brain MR images was earlier explored in “Brain Hallucination” by Rousseau in the Proceedings of the 10th European Conference on Computer Vision: Part I. pp. 497-508. ECCV '08, Springer-Verlag (2008). For the MS dataset, the MPRAGE resolution is 0.82×0.82×1.1 mm³, whereas the acquired T₂-w image resolution is 0.82×0.82×2.2 mm³. When using these two images aligned together for any purpose, the T₂-w image has to be registered to the higher resolution MPRAGE image by creating intermediate slices through interpolation. However, this blurs the image details in the through plane direction. It was decided to synthesize a T₂-w image using an atlas collection which had similar resolution MPRAGE and T₂-w data (both 1.1 mm through plane). The higher resolution T₂-w image was then synthesized from the subject MPRAGE and visually compared with the 2.2 mm resolution T₂-w image. The results are shown in FIG. 5, where the quality and resolution of the newly synthesized image is visually superior to the original acquisition.

The techniques described herein, therefore, provide for pulse sequence-based intensity normalization and contrast synthesis for MRI. In particular, the techniques herein propose an MR image pre-processing framework, PSRR, which allows performance of MR image synthesis and scanner normalization by incorporating relevant information from the imaging physics which leads to real MR image formation. In addition, the techniques herein provide a significantly higher quality of image normalization and synthesis than the state-of-the-art methods in addition to being fast.

Notably, while there have been shown and described illustrative embodiments that provide for pulse sequence-based intensity normalization and contrast synthesis for MRI, it is to be understood that various other adaptations and modifications may be made within the spirit and scope of the embodiments herein. For example, the embodiments have been shown and described herein with relation to particular types of imaging is parameters (e.g., TR, TE, flip angle (α)) and physical properties of the underlying tissue (e.g., biophysical properties (β=[P_{D}, T₁, T₂]). However, the embodiments in their broader sense are not as limited, and may, in fact, be used with other types of parameters and/or properties where suitable, such as those others mentioned above or others understood in the art but not explicitly mentioned herein.

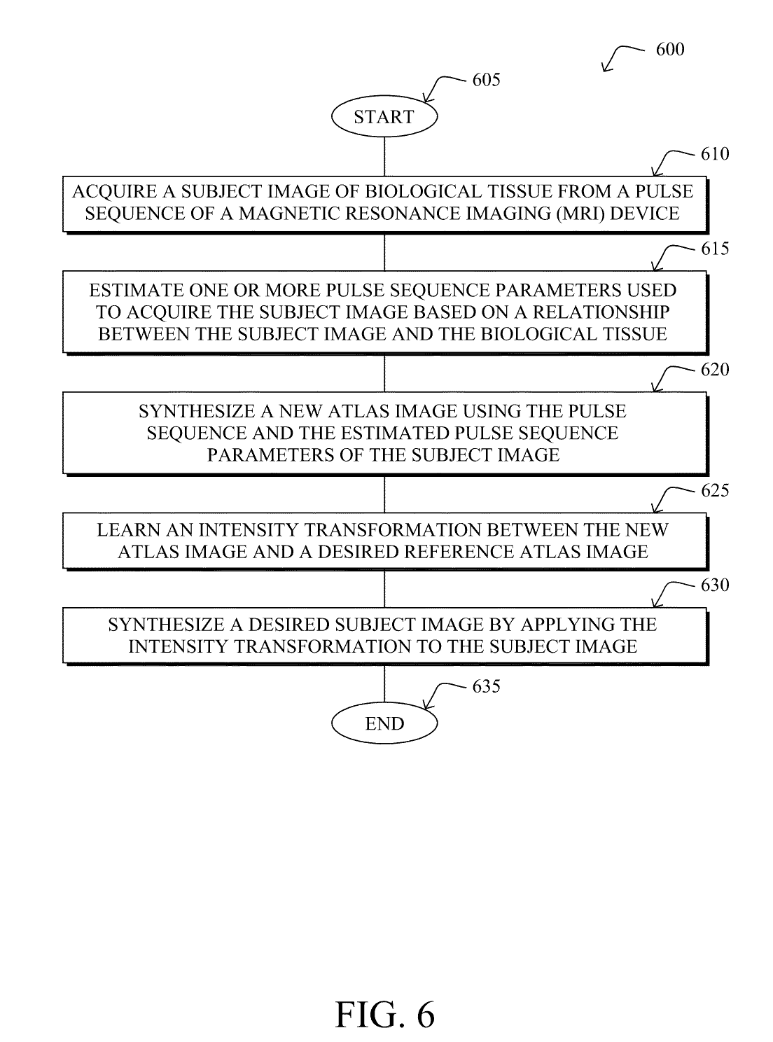

FIG. 6 illustrates an example simplified procedure 600 for providing for pulse sequence-based intensity normalization and contrast synthesis for MRI in accordance with one or more embodiments described herein. The procedure 600 may start at step 605, and continues to step 1010, where, as described in greater detail above, a subject image of biological tissue is acquired from a pulse sequence of an MRI device (e.g., using a plurality of image acquisitions). In step 615, the techniques herein estimate one or more pulse sequence parameters used to acquire the subject image (e.g., repetition time (TR), echo time(s) (TE), flip angle (α), and scanner gain (A₀)) based on a relationship between the subject image and the biological tissue. For example, as mentioned above, estimating the pulse sequence parameters may be based on known mean intensities of tissue classes for biological tissue (e.g., white matter (WM), grey matter (GM), and cerebrospinal fluid (CSF)) and known mean values for tissue properties for the tissue classes (e.g., proton density (P_{D}), longitudinal relaxation time (T₁), and transverse relaxation time (T₂)).

In step 620, a new atlas image may be synthesized as detailed above using the pulse sequence and the estimated pulse sequence parameters of the subject image. In particular, as described above, synthesizing the new atlas image may comprise estimating a theoretical betaspace for properties of the biological tissue by applying a plurality of intensities to pulse sequence equations (e.g., approximations) based on the estimated pulse sequence parameters, and applying a desired pulse sequence equation for the desired pulse sequence to the theoretical betaspace to synthesize the new atlas image.

In step 625 an intensity transformation between the new atlas image and a desired reference atlas image may be learned, accordingly. For instance, learning the intensity transformation between the new atlas image and the desired reference atlas image may be based on one or more non-linear regression learning algorithms. In step 630, a desired is subject image may be synthesized by applying the intensity transformation to the subject image in a manner as described above, to thus synthesize an intensity normalized image of the subject image (where the desired reference atlas image comprises an image to which the subject image is normalized) or to synthesize a selected pulse sequence image of the subject image (where the desired reference atlas image comprises a reference atlas image of the selected pulse sequence). As noted above, an example selected pulse sequence may be a pulse sequence not obtained by the MRI for the biological tissue or a pulse sequence not obtainable by the MRI for the biological tissue.

The illustrative procedure 600 ends in step 635, with the ability to augment the reference atlas to include synthesized atlas images using the subject image pulse sequence and the corresponding subject image pulse sequence parameters. It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

Illustratively, the techniques described herein may be performed by hardware, software, and/or firmware, such as in accordance with an MRI process, which may contain computer executable instructions executed by a processor to perform functions relating to the techniques described herein. For example, the techniques herein may be treated as extensions to conventional MRI processes, and as such, may be processed by similar components understood in the art that execute those protocols, accordingly.

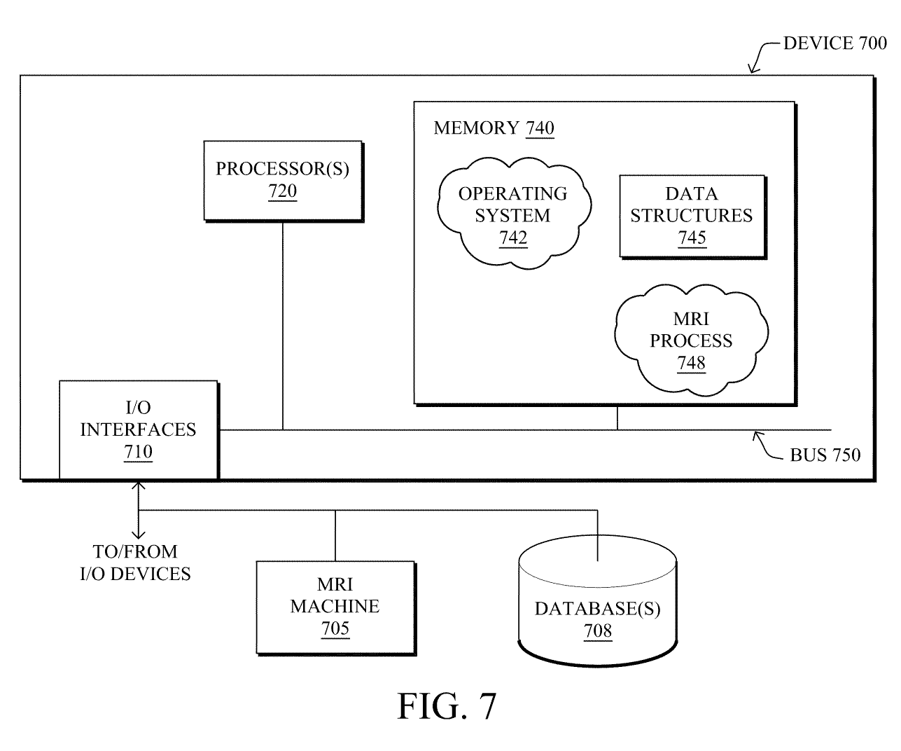

For example, FIG. 7 is a schematic block diagram of an example computing device 700 that may be used with one or more embodiments described herein, e.g., as a standalone computation device (receiving data from an MRI machine 705 or a database 708), or else as an integrated computational device attached to an MRI machine 705. The device comprises one or more input/output (I/O) interfaces 710, one or more processors 720, and a memory 740 interconnected by a system bus 750. The I/O interfaces 710 contain the mechanical, electrical, and signaling circuitry for communicating data between various components, such as user interfaces (e.g., keyboards, monitors, etc.), other devices (e.g., direct and/or network connections), etc. The memory 740 comprises a plurality of storage locations that are addressable by the processor(s) 720 for storing software programs and data structures associated with the embodiments described herein. The processor 720 may comprise necessary elements or logic adapted to execute the software programs and manipulate the data structures 745. An operating system 742, portions of which are typically resident in memory 740 and executed by the processor(s), functionally organizes the device by, inter alia, invoking network operations in support of software processes and/or services executing on the device. These software processes and/or services may comprise an illustrative MRI process 748. In particular, MRI process 748 may contain computer executable instructions executed by processor 720 to perform functions in accordance with standard MR imaging techniques, enhanced by the techniques described herein in accordance with one or more of the illustrative embodiments above.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on is a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
acquiring a subject image of biological tissue from a pulse sequence of a magnetic resonance imaging (MRI) device;
estimating one or more pulse sequence parameters used to acquire the subject image based on a relationship between the subject image and the biological tissue;
synthesizing a new atlas image using the pulse sequence and the estimated pulse sequence parameters of the subject image;
learning an intensity transformation between the new atlas image and a desired reference atlas image; and
synthesizing a desired subject image by applying the intensity transformation to the subject image.

2. The method as in claim 1, wherein the desired subject image comprises an intensity normalized image of the subject image and the desired reference atlas image comprises an image to which the subject image is normalized.

3. The method as in claim 1, wherein the desired subject image comprises a selected pulse sequence image of the subject image and the desired reference atlas image comprises a reference atlas image of the selected pulse sequence.

4. The method as in claim 3, wherein the selected pulse sequence comprises one of either a pulse sequence not obtained by the MRI for the biological tissue or a pulse sequence not obtainable by the MRI for the biological tissue.

5. The method as in claim 1, wherein the estimated pulse sequence parameters comprise one or more of repetition time (TR), echo time(s) (TE), flip angle (α), scanner gain (A₀), and inverse time (TI).

6. The method as in claim 1, wherein estimating the pulse sequence parameters is based on known mean intensities of tissue classes for biological tissue and known mean values for tissue properties for the tissue classes.

7. The method as in claim 6, wherein tissue classes are selected from a group consisting of: white matter (WM), grey matter (GM), and cerebrospinal fluid (CSF).

8. The method as in claim 6, wherein tissue properties are selected from a group consisting of: proton density (P_{D}), longitudinal relaxation time (T₁), and transverse relaxation time (T₂).

9. The method as in claim 1, wherein learning the intensity transformation between the new atlas image and the desired reference atlas image is based on one or more nonlinear regression learning algorithms.

10. The method as in claim 1, wherein synthesizing the new atlas image comprises:
estimating a theoretical betaspace for properties of the biological tissue by applying a plurality of intensities to pulse sequence equations based on the estimated pulse sequence parameters; and
applying a desired pulse sequence equation for the desired pulse sequence to the theoretical betaspace to synthesize the new atlas image.

11. The method as in claim 10, wherein the pulse sequence equations comprise approximations.

12. The method as in claim 1, wherein acquiring the subject images comprises a plurality of image acquisitions.

13. The method as in claim 1, further comprising: augmenting the reference atlas to include synthesized atlas images using the subject image pulse sequence and the corresponding subject image pulse sequence parameters.

14. An apparatus, comprising:
a processor; and
a memory having a process stored thereon, the process when executed by the processor operable to:
acquire a subject image of biological tissue from a pulse sequence of a magnetic resonance imaging (MRI) device;
estimate one or more pulse sequence parameters used to acquire the subject image based on a relationship between the subject image and the biological tissue;
synthesize a new atlas image using the pulse sequence and the estimated pulse sequence parameters of the subject image;
learn an intensity transformation between the new atlas image and a desired reference atlas image; and
synthesize a desired subject image by applying the intensity transformation to the subject image.

15. The apparatus as in claim 14, wherein the desired subject image comprises an intensity normalized image of the subject image and the desired reference atlas image comprises an image to which the subject image is normalized.

16. The apparatus as in claim 14, wherein the desired subject image comprises a selected pulse sequence image of the subject image and the desired reference atlas image comprises a reference atlas image of the selected pulse sequence.

17. The apparatus as in claim 14, wherein estimating the pulse sequence parameters is based on known mean intensities of tissue classes for biological tissue and known mean values for tissue properties for the tissue classes.

18. The apparatus as in claim 14, wherein the process when executed to synthesize the new atlas image is operable to:
estimate a theoretical betaspace for properties of the biological tissue by applying a plurality of intensities to pulse sequence equations based on the estimated pulse sequence parameters; and
apply a desired pulse sequence equation for the desired pulse sequence to the theoretical betaspace to synthesize the new atlas image.

19. The apparatus as in claim 18, wherein the pulse sequence equations comprise approximations.

20. A tangible, non-transitory computer-readable medium having program instructions thereon, the program instructions when executed by a processor operable to:
acquire a subject image of biological tissue from a pulse sequence of a magnetic resonance imaging (MRI) device;
estimate one or more pulse sequence parameters used to acquire the subject image based on a relationship between the subject image and the biological tissue;
synthesize a new atlas image using the pulse sequence and the estimated pulse sequence parameters of the subject image;
learn an intensity transformation between the new atlas image and a desired reference atlas image; and
synthesize a desired subject image by applying the intensity transformation to the subject image.
